(19) United States
(12) Patent Application Publication
(10) Pub. No.: US 2021/0382160 A1
(43) Pub. Date: Dec. 9, 2021

(54) METHOD FOR OPERATING AN OFDM RADAR SYSTEM

(71) Applicant: Robert Bosch GmbH, Stuttgart (DE)

(72) Inventors: Daniel Schindler, Ludwigsburg (DE); Juergen Hasch, Stuttgart (DE)

(21) Appl. No.: 17/287,354

(22) PCT Filed: Dec. 7, 2019
(86) PCT No.: PCT/EP2019/084108

§ 371 Date: Apr. 21, 2021

(30) Foreign Application Priority Data
Mar. 7, 2019 (DE) 10 2019 203 135.8

(51) Int. Cl. G01S 13/34; G01S 13/58; G01S 7/35

(52) U.S. Cl. CPC G01S 13/347; G01S 13/931; G01S 7/352; G01S 13/584

(57) ABSTRACT

A method for operating an OFDM radar system. The method includes: generating an analog transmit signal in the baseband; mixing the analog transmit signal with a first mixed signal at a first frequency, the first frequency of the first mixed signal lying centrally between two sidebands of a transmission band; receiving a received signal; mixing the received signal with a second mixed signal at a second frequency into the baseband, the second frequency of the second mixed signal lying in a defined manner adjacent to a total bandwidth of the received signal.

### FIELD

The present invention relates to a method for operating an OFDM radar system. The present invention furthermore relates to a transmitting device of an OFDM radar system. The present invention furthermore relates to a receiving device of an OFDM radar system. The present invention furthermore relates to an OFDM radar system. The present invention furthermore relates to a computer program product.

### BACKGROUND INFORMATION

A radar system emits a signal which is reflected by objects in the radar channel. The reflected signal is received and evaluated to detect distance, velocity, and angle relative to the sensor of the vehicle. The employed and modulated signal may also be generated with the aid of OFDM (orthogonal frequency division multiplexing).

German Patent Application No. DE 10 2015 210 454 A1 describes a method for operating an OFDM radar device, in which a distance separating capability is obtained without deductions in relation to a conventional combination made up of OFDM and MIMO, a distance range which may be clearly estimated not being reduced.

### SUMMARY

It is an object of the present invention to provide an improved method for operating an OFDM radar system.

The object may be achieved according to a first aspect by a method for operating an OFDM radar system in accordance with the present invention. In accordance with an example embodiment of the present invention, the method includes the steps:
generating an analog transmit signal in the baseband;
mixing the analog transmit signal with a first mixed signal at a first frequency, the first frequency of the first mixed signal lying centrally between two sidebands of a transmission band;
receiving a received signal; and
mixing the received signal with a second mixed signal at a second frequency in the baseband, the second frequency of the second mixed signal lying in a defined manner adjacent to a total bandwidth of the received signal.

In this way, a method is provided, using which an improved distance resolution for the OFDM radar system is provided because of the increased bandwidth of the received signal or less technical effort is necessary with lower distance resolution.

According to a second aspect of the present invention, the object may be achieved by a transmitting device for an OFDM radar system. In accordance with an example embodiment of the present invention, the transmitting device includes:
a storage unit for storing a digital transmit signal;
a first D/A converter functionally connected to the storage unit for generating an analog transmit signal;
a first mixer unit functionally connected to the first D/A converter; and
a first oscillator unit functionally connected to the first mixer unit, the analog transmit signal being mixed in a transmission spectrum having two sidebands with the aid of the first oscillator unit and the first mixer unit, the first frequency of the first oscillator unit lying centrally between the two sidebands, the analog transmit signal being emitted with the aid of a transmitting antenna.

In this way, a transmitting device is advantageously provided which only has half a path in relation to a conventional transmitting device of an OFDM radar system. As a result, the distance resolution of the OFDM radar system may advantageously also be doubled.

According to a further aspect of the present invention, the object may achieved by a receiving device of an OFDM radar system. In accordance with an example embodiment of the present invention, the receiving device includes:
a receiving antenna for receiving a received signal;
a second mixer unit functionally connected to the receiving antenna for mixing the received signal in the baseband;
a third mixer unit functionally connected to the second mixer unit for generating a second mixed signal at a second frequency;
an A/D converter functionally connected to the second mixer unit;
the second frequency of the second mixed signal being offset in a defined manner to the bandwidth of the received signal.

The expenditure for the receiving device of the OFDM radar system is thus advantageously only insignificantly increased over the related art.

Preferred specific embodiments of the provided method and the provided receiving device in accordance with the present invention are described herein.

One preferred advantageous refinement of the method provides that the second frequency of the second mixed signal is generated from the first frequency of the first mixed signal. An expenditure for generating the mixed signals may thus advantageously be minimized, because only a single oscillator is provided for this purpose.

A further preferred refinement of the method provides that the second frequency of the second mixed signal is generated independently of the first frequency of the first mixed signal, a defined correlation of phase noises of the two frequencies being provided. This advantageously assists a physical distance between transmitting and receiving devices also being able to be made larger, because independent oscillators are used for generating the mixed signals.

One advantageous refinement of the receiving device in accordance with the present invention provides that the second frequency of the second mixed signal is above or below the bandwidth of the received signal. Different frequencies may thus be selected for the mixed signals depending on the design of the OFDM radar system.

Another advantageous refinement of the receiving device in accordance with the present invention provides that a frequency offset between the second frequency and a first frequency of the first mixed signal is generated with the aid of a digital component. A simple generation of the frequency offset between the mixed signals may thus advantageously be implemented.

Another advantageous refinement of the receiving device in accordance with the present invention provides that the frequency offset between the frequencies of the mixed signals is generated with the aid of a voltage-controlled component in combination with a PLL component. An alternative way of generating the frequency offset of the mixed signals thus advantageously results.

Another advantageous refinement of the receiving device in accordance with the present invention provides that the second frequency is generated from the first frequency or the second frequency is generated separately. Different possibilities for providing the second mixed signal thus advantageously result.

Another advantageous refinement of the receiving device in accordance with the present invention provides that the distance of the second frequency to the bandwidth of the received signal is an integer multiple of an interval of frequency lines of the sidebands of the received signal. The entire OFDM radar system is thus advantageously adapted to a structure of the OFDM signal, whereby a distance resolution of the entire OFDM radar system is optimized.

The present invention is described in detail hereinafter with further features and advantages on the basis of multiple figures. All features described or shown form the subject matter of the present invention for itself or in any arbitrary combination, independently of their wording or representation in the description herein or in the figures. Identical or functionally identical elements have identical reference numerals.

Described method features result similarly from corresponding described device features and vice versa. This means in particular that features, technical advantages, and statements relating to the method result similarly from corresponding statements, features, and advantages of the transmitting device and the receiving device and vice versa.

### BRIEF DESCRIPTION OF THE DRAWINGS

FIG. 1 shows a schematic block diagram of a conventional OFDM radar system.

FIG. 2 shows a schematic block diagram of an embodiment of a provided transmitting device of an OFDM radar system, in accordance with the present invention.

FIG. 3 shows a schematic view of a reception spectrum of a provided receiving device of an OFDM radar system, in accordance with the present invention.

FIG. 4 shows a schematic block diagram of a specific embodiment of a provided receiving device of an OFDM radar system, in accordance with the present invention.

FIG. 5 shows a schematic block diagram of another specific embodiment of a provided receiving device of an OFDM radar system, in accordance with the present invention.

FIG. 6 shows the receiving device of FIG. 4 in a higher degree of detail, in accordance with the present invention.

FIG. 7 shows a schematic sequence of a provided method for operating an OFDM radar system, in accordance with an example embodiment of the present invention.

FIG. 8 shows a block diagram of a provided OFDM radar system, in accordance with an example embodiment of the present invention.

### DETAILED DESCRIPTION OF EXAMPLE EMBODIMENTS

OFDM signals are upmixed in the transmitter in the sideband mode and downmixed in the receiver with an intermediate frequency to evaluate both sidebands. Twice as high a resolution also results due to the doubled generated bandwidth.

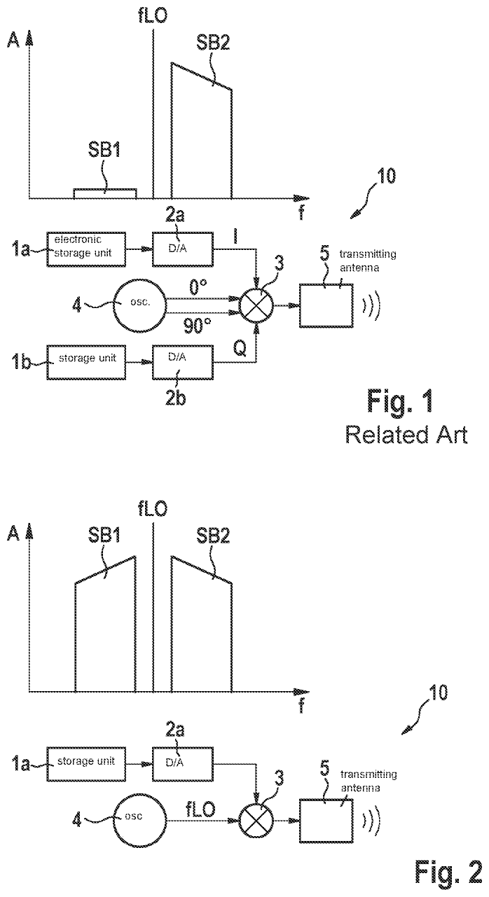

FIG. 1 shows a simplified overview circuit diagram of a conventional radar system 100 based on the orthogonal frequency division multiplexing method OFDM. In an electronic storage unit 1a (for example a RAM), digital information of a transmit signal is stored, for example a sequence of discrete equidistant transmit frequencies or OFDM subcarriers to be emitted. For example, complex sampled values of a baseband transmit signal are generated by an inverse fast Fourier transform iFFT, these values being stored in electronic storage unit 1a, from which they may be read out cyclically.

A D/A converter 2a generates a cyclic complex analog baseband signal from the sequence read out periodically from storage unit 1a.

With the aid of a first mixer unit 3 and an oscillator unit 4, the baseband transmit signal is shifted into the desired frequency range (for example 77 . . . 78 GHz) and then emitted by a transmitting antenna 5, in the automotive field, for example using a carrier frequency of 77 GHz.

If a simple mixer is used, two sidebands SB1, SB2 thus result. If the receiver mixes using the same carrier frequency in the baseband (around f=0 Hz), the bands fold on one another and cause undesired interference, in particular in dynamic scenarios. Therefore, an IQ mixer may be used in the transmitter which suppresses the second sideband. However, a hardware complexity in the transmitter is thus increased by the factor of two, since I and Q signals each have to be generated separately via D/A converters and stored beforehand. An intermediate frequency system may also be used which uses a filter either in the transmitter and receiver to suppress the undesired sideband.

A second path is apparent of transmitting device 10 having a second storage unit 1b and a second D/A converter 2a, which is used to largely eliminate a first sideband SB1. This is used so that the baseband may be processed in the receiver channel.

FIG. 2 shows a first specific embodiment of a provided transmitting device 10 for an OFDM radar system 100. It is apparent that now only a single path having a storage unit 1a and a D/A converter 2a is provided, which is used to upmix the analog transmit signal using a first oscillator unit 4. The OFDM-modulated transmit signal is generated with the aid of first mixing unit 3 (double-sideband mixer) and thus has a transmission bandwidth of 2×B, if the modulation bandwidth of the baseband signal is B. As a result, a transmission spectrum of the transmit signal as shown in FIG. 2 thus results, which has two sidebands SB1, SB2, the frequency of mixed signal fLO lying centrally between the two sidebands SB1, SB2. In this form, however, the transmit signal could not be processed by a receiving device, because mirror effects occur upon downmixing, whereby the sidebands mutually overlap.

Because transmitting device 10 operates in the double-sideband mode, it does not require an IQ mixer as in the related art. Second D/A converter 2a and digital storage unit 1b required for this purpose of conventional transmitting device 10 are thus advantageously omitted. In addition, at equal sampling rate in transmitting device 10, the generated analog signal bandwidth of transmitting device 10 is increased by the factor of two, which advantageously doubles the possible distance resolution of the OFDM radar system.

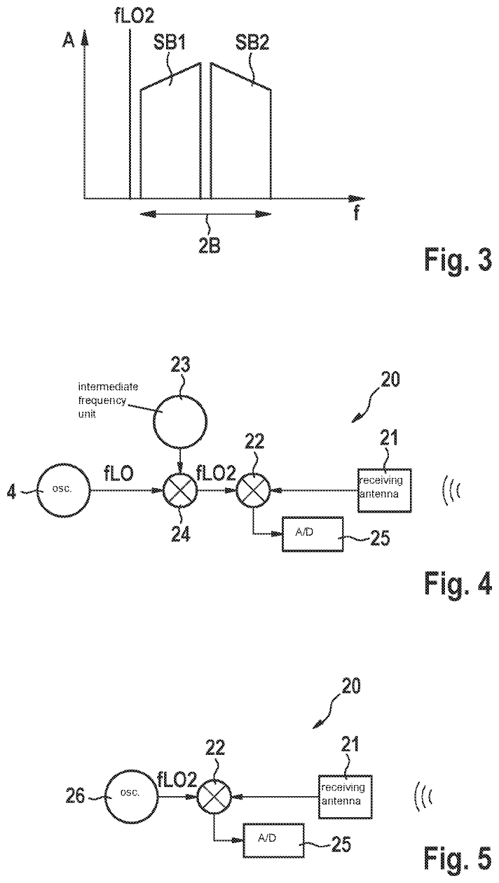

Furthermore, a receiving device 20 for an OFDM radar system is provided for processing the transmit signal emitted by transmitting device 10, using which a reception spectrum as shown in FIG. 3 is obtained. For provided receiving device 20, a second mixer 22 in the form of a double-sideband mixer may be used, if an oscillator signal offset by bandwidth B is available at frequency fLO2. This enables only a single A/D converter 25 to be used for sampling the received signal. In this case, frequency fLO2 of the oscillator signal is adjacent to the entire bandwidth of the received signal, as may be seen in FIG. 3. In the case of FIG. 3, frequency fLO2 is above first sideband SB1, however, it could also be above second sideband SB2 (not shown).

In contrast to applications in communication technology, in radar applications the coding information on the subcarriers is not used, but is eliminated in receiving device 20 by spectral division, so that only the channel information remains on the carriers. Since second sideband SB2 is a complex-conjugated and mirrored copy of first sideband SB1 in this case, both sidebands SB1, SB2 contain the same code, but pass through different frequency points in the channel and thus have nonredundant channel information.

In provided receiving device 20, mixing is carried out with the aid of an intermediate frequency in such a way that both sidebands SB1, SB2 may be evaluated. The sampling rate of A/D converter 25 has to be set in such a way that both sidebands SB1, SB2 are sampled clearly and completely. The bandwidth thus evaluated (distance resolution) is then twice as high as the bandwidth of the transmit signal generated with the aid of transmitting device 10.

The oscillator frequencies for the mixed signals may be between 57 GHz and 300 GHz, for automobile radar preferably between 76 GHz and 81 GHz. The interval between frequencies fLO and fLO2 of the mixed signals is calculated as:

fLO2≈fLO±B (1)

where:
B . . . modulation bandwidth of the OFDM signals (for example between 1 MHz and 2 GHz)

FIG. 4 shows a schematic block diagram of a first variant of provided receiving device 20. To ensure correlated phase noise between provided transmitting device 10 and provided receiving device 20, the same oscillator signal may be used for transmitting device 10 and receiving device 20. The required intermediate frequency for transmitting device 10 and receiving device 20 may be generated with the aid of a ZF unit 23, a third mixer unit 24 in the form of an IQ mixer, and a second frequency source (for example DDS (direct digital synthesis (not shown)) or VCO (voltage-controlled oscillator (not shown)). Since the intermediate frequency may be generated at low frequencies (for example at 1 GHz), the added phase noise is thus less. Since carrier frequency and intermediate frequency are generally mixed at a fixed frequency, third mixer unit 24 may be tuned precisely to this frequency behavior.

This is achieved using receiving device 20 of FIG. 4. In receiving device 20, the received signal is mixed and sampled using an oscillator signal offset by bandwidth B. The two emitted sidebands SB1, SB2 may thus be reproduced, without an IQ receiving mixer being required for this purpose.

First oscillator unit 4 is apparent, which is functionally connected together with an intermediate frequency unit 23 to a third mixer unit 24. The received signal received via a receiving antenna 21 may thus be mixed with the aid of second mixer unit 22 into the baseband and may subsequently be evaluated using an A/D converter 25. A digital, complex time signal is thus provided in the baseband at the output of A/D converter 25. For this purpose, A/D converter 25 has to be designed in such a way that it may sample the complete reception spectrum. In this way, a bandwidth 2B is obtained for the received signal, which may significantly improve the distance resolution of provided OFDM radar system 100.

FIG. 5 shows a second variant of provided receiving device 20. In this case, the frequency for the mixed signal of the received signal is generated separately by transmitting device 10, for which separate oscillator units 4, 26 of transmitting device 10 and receiving device 20 may be used in each case. The phase noise of the two oscillator units 4, 26 is no longer correlated in this configuration, this being able to be improved with the aid of a coupling (for example, via an identical reference (not shown)) of the two oscillator units 4, 26, however.

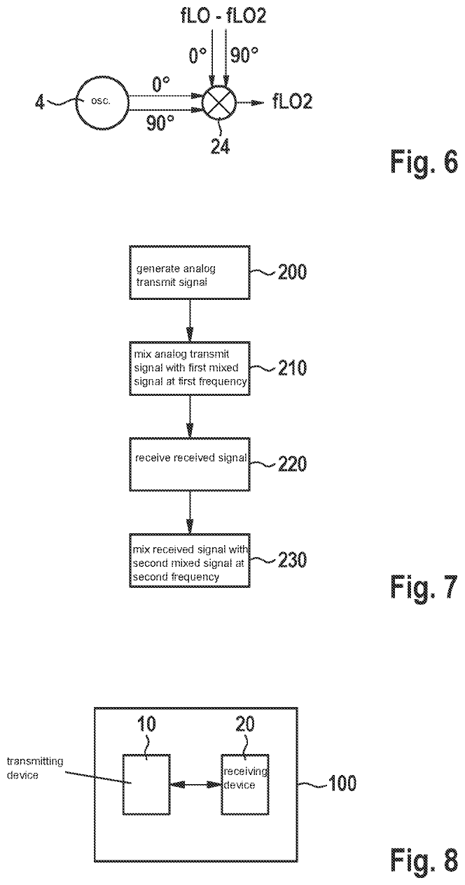

FIG. 6 shows a detail of the receiving device of FIG. 4, a way of generating the frequency offset between oscillator frequency fLO of transmitting device 10 and oscillator frequency fLO2 of receiving device 20 being shown in greater detail. A difference of mentioned oscillator frequencies fLO, fLO2 is supplied to third mixer unit 24 and upmixed with the aid of first oscillator unit 4 into the reception band according to FIG. 3.

The following table shows several technical parameters in the comparison between a conventional OFDM radar system and a provided OFDM radar system:

TABLE

| | | |
|---|---|---|
| | | According to the |
| Parameters | Related art | present invention |

| | |
|---|---|
| Carrier frequency | 79 GHz |
| OFDM useful bandwidth | 2 GHz |
| Measuring period | 1 ms |

| | | |
|---|---|---|
| Number of D/A | 2 | 1 |
| converters per | | |
| transmission channel | | |

| | | | | |
|---|---|---|---|---|
| D/A sampling rate | 4 | GS/s | 2 | GS/s |
| Total sampling rate | 8 | GS/s | 2 | GS/s |
| per transmission | | | | |
| channel | | | | |
| Digital storage in | 8 | MS | 2 | MS |
| the transmitter | | | | |

It is apparent that significant technical parameters of OFDM radar system 100 according to the present invention are halved numerically and therefore essentially only require half of the technical expenditure for their implementation.

FIG. 7 shows a schematic sequence of a provided method for operating an OFDM radar system 100.

In a step 200, an analog transmit signal is generated in the baseband.

In a step 210, mixing of the analog transmit signal with a first mixed signal at a first frequency fLO is carried out, first frequency fLO of the first mixed signal lying centrally between two sidebands SB1, SB2 of a transmission band.

In a step 220, a received signal is received.

Finally, in a step 230, mixing of the received signal with a second mixed signal is carried out at a second frequency fLO2 in the baseband, second frequency fLO2 of the second mixed signal lying in a defined manner adjacent to a total bandwidth 2B of the received signal.

Alternatively, it is also possible to carry out some of the signal processing steps in other sequences than those shown.

Optimum utilization of existing resources of the OFDM radar system is assisted by the provided method.

Although the described method was described exclusively in conjunction with OFDM radar systems, an application for other systems including digital multicarrier modulation is also possible, in particular in the radar field.

FIG. 8 shows a block diagram of a provided OFDM radar system 100 including a provided transmitting device 10 and a provided receiving device 20.

The provided method may advantageously also be designed as a software program which runs on electronic OFDM radar system 100, whereby an adaptability of the method is advantageously assisted.

The person skilled in the art will suitably modify the described features of the present invention and combine them with one another without departing from the core of the present invention.

1-12. (canceled)

13. A method for operating an OFDM radar system, comprising the following steps:
generating an analog transmit signal in a baseband;
mixing the analog transmit signal with a first mixed signal at a first frequency, the first frequency of the first mixed signal lying centrally between two sidebands of a transmission band;
receiving a received signal; and
mixing the received signal with a second mixed signal at a second frequency into the baseband, the second frequency of the second mixed signal lying in a defined manner adjacent to a total bandwidth of the received signal.

14. The method as recited in claim 13, wherein the second frequency of the second mixed signal is generated from the first frequency of the first mixed signal.

15. The method as recited in claim 13, wherein the second frequency of the second mixed signal is generated independently of the first frequency of the first mixed signal, a defined correlation of phase noise of the first and second frequencies being provided.

16. A transmitting device of an OFDM radar system, comprising:
a storage unit configured to store a digital transmit signal;
a first D/A converter functionally connected to the storage unit configured to generate an analog transmit signal;
a first mixer unit functionally connected to the first D/A converter; and
a first oscillator unit functionally connected to the first mixer unit, the analog transmit signal being mixed into a transmission spectrum including two sidebands using the first oscillator unit and the first mixer unit, the first frequency of the first oscillator unit lying centrally between the two sidebands, the analog transmit signal being emitted using a transmitting antenna.

17. A receiving device of an OFDM radar system, comprising:
a receiving antenna configured to receive a received signal;
a second mixer unit functionally connected to the receiving antenna and configured to mix the received signal into a baseband;
a third mixer unit functionally connected to the second mixer unit and configured to generate a second mixed signal including a second frequency; and
an A/D converter functionally connected to the second mixer unit;
wherein the second frequency of the second mixed signal is offset in a defined manner to the bandwidth of the received signal.

18. The receiving device as recited in claim 17, wherein the second frequency of the second mixed signal is above or below the bandwidth of the received signal.

19. The receiving device as recited in claim 17, wherein a frequency offset between the second frequency and a first frequency of a first mixed signal is generated using a digital component.

20. The receiving device as recited in claim 19, wherein a frequency offset between the first and second frequencies of the first and second mixed signals is generated using a voltage-controlled component in combination with a PLL component.

21. The receiving device as recited in claim 19, wherein the second frequency is generated from the first frequency or the second frequency is generated separately.

22. The receiving device as recited in claim 17, wherein an interval of the second frequency to the bandwidth of the received signal is an integer multiple of an interval of frequency lines of the sidebands of the received signal.

23. An OFDM radar system, comprising:
a transmitting device, including:
a storage unit configured to store a digital transmit signal,
a first D/A converter functionally connected to the storage unit configured to generate an analog transmit signal,
a first mixer unit functionally connected to the first D/A converter, and
a first oscillator unit functionally connected to the first mixer unit, the analog transmit signal being mixed into a transmission spectrum including two sidebands using the first oscillator unit and the first mixer unit, the first frequency of the first oscillator unit lying centrally between the two sidebands, the analog transmit signal being emitted using a transmitting antenna; and
a receiving device, including:
a receiving antenna configured to receive a received signal;
a second mixer unit functionally connected to the receiving antenna and configured to mix the received signal into a baseband;
a third mixer unit functionally connected to the second mixer unit and configured to generate a second mixed signal including a second frequency; and
an A/D converter functionally connected to the second mixer unit;
wherein the second frequency of the second mixed signal is offset in a defined manner to the bandwidth of the received signal.

24. A non-transitory computer-readable data carrier on which is stored a computer program including program code for operating an OFDM radar system, the program code, when executed by a computer, causing the computer to perform the following steps:
generating an analog transmit signal in a baseband;
mixing the analog transmit signal with a first mixed signal at a first frequency, the first frequency of the first mixed signal lying centrally between two sidebands of a transmission band;
receiving a received signal; and
mixing the received signal with a second mixed signal at a second frequency into the baseband, the second frequency of the second mixed signal lying in a defined manner adjacent to a total bandwidth of the received signal.
